(19) United States
(12) Patent Application Publication
(10) Pub. No.: US 2019/0074904 A1
(43) Pub. Date: Mar. 7, 2019

(54) CATV Point Of Entry Adapter

(71) Applicant: PCT International Inc., Mesa, AZ (US)

(72) Inventor: Kang Lin, Chandler, AZ (US)

(73) Assignee: PCT International Inc., Mesa, AZ (US)

(21) Appl. No.: 15/988,389

(22) Filed: May 24, 2018

Related U.S. Application Data
(60) Provisional application No. 62/553,698, filed on Sep. 1, 2017.

(51) Int. Cl. H04B 10/2575; H04L 5/02

(52) U.S. Cl. CPC H04B 10/25751; H04L 5/02

(57) ABSTRACT

A CATV point of entry adapter includes an input for receiving CATV signals, a splitter having a plurality of outputs, and a plurality of first diplex filters. Each of the diplex filters has a low-pass port passing the CATV signals and a high-pass port passing MoCA signals. Each of the outputs of the splitter is connected to one of the low-pass ports of the diplex filters for passing the CATV signals between the input and the diplex filters. The adapter further includes access network ports, each coupled to the diplex filters for passing both the CATV and MoCA signals between the diplex filters and the access network ports. The adapter also includes splitter means having home network ports, wherein the splitter means is connected to the high-pass ports of the diplex filters for passing the MoCA signals between the splitter means and the first diplex filters.

### CROSS-REFERENCE TO RELATED APPLICATIONS

This application claims the benefit of U.S. Provisional Application No. 62/553,698, filed Sep. 1, 2017, which is hereby incorporated by reference.

### FIELD OF THE INVENTION

The present invention relates generally to data communication devices, and more particularly to adapters for controlling MoCA signals in a CATV network.

### BACKGROUND OF THE INVENTION

In recent years, CATV operators have transformed their services from providing standard cable television entertainment content only to providing television, voice, security, and broadband services, all through a single cable or transmission line. As a result, modern communications infrastructures have had to meet rising multimedia demand by providing much larger amounts of bandwidth as both the number of subscribers have increased and the services those subscribers use have increasingly consumed more bandwidth. For instance, bandwidth-intensive internet applications such as file sharing, video conferencing, e-commerce, and audio and video streaming have become incredibly popular. To address this rising demand, some cable operators have upgraded their hardware installations, such as by at least partially replacing their networks with fiber-based technologies, to carry more data than conventional cable systems.

Hybrid fiber-coaxial (“HFC”) systems transmit data using the Data Over Cable Services Interface Specification (“DOCSIS”) standard for bi-directional data transmission, with return path signals being transmitted to an HFC plant to provide information about the system, such as the operability, status, load, or use of the system and by the consumer. In traditional HFC systems, a cable enters the subscriber's premises (such as a home or office), or external point-of-entry, and then extends to a modem or several electronic components. Downstream signals are transmitted along the cable, and return path signals originate from cable modems, Embedded Multimedia Terminal Adapters (“eMTAs”), and settop boxes and are transmitted back to the operator. Such electronic components transmit return path signals in the 5-42 MHz range (though in other countries, other frequency bands are used, such as 5-30 MHz, 5-55 MHz, and 5-65 MHz). These return path signals for a single home are combined at the premises entry points, or CATV Points of Entry (“POE”), by RF combiners, and then return path signals from multiple premises are combined, generally by an RF tap or through a fiber optic network further up the access network.

The electronic components in each home produce ingress noise, however. Ingress noise is caused by construction or installation imperfections in the electronic components or cables, poor shielding, distortions, and other sources. Consequently, in addition to combining the desired RF signals and transmitting them along the return path, network hardware transmits ingress noise as well. As return path signals are aggregated from multiple premises, ingress noise becomes a problem and impacts signal quality.

Multimedia over Coax Alliance (“MoCA”) standards were developed to allow multimedia devices to be used at different locations within a home. MoCA has created in-home coaxial cable infrastructure standards. Although using the infrastructure as the communication medium substantially simplifies implementation of the MoCA network, there are certain disadvantages to doing so.

MoCA signals pass through the CATV POE and enter the CATV network infrastructure. Those signals may then pass through a drop cable and into another subscriber's premises. If so, the presence of the MoCA signals at a neighboring subscriber's premises compromises the privacy and security of information in the signal. Such information is intended to be confined and known only to the subscriber (or the subscriber's components) transmitting the information. Additionally, passing the MoCA signals through a neighboring subscriber's premises has the potential to adversely affect the performance of the MoCA network in the neighboring subscriber's premises.

### SUMMARY OF THE INVENTION

In an embodiment, a CATV point of entry adapter includes an input for receiving CATV signals, a splitter having a plurality of outputs, and a plurality of first diplex filters. Each of the diplex filters has a low-pass port passing the CATV signals and a high-pass port passing MoCA signals. Each of the outputs of the splitter is connected to one of the low-pass ports of the diplex filters for passing the CATV signals between the input and the diplex filters. The adapter further includes access network ports, each coupled to the diplex filters for passing both the CATV and MoCA signals between the diplex filters and the access network ports. The adapter also includes splitter means having home network ports, wherein the splitter means is connected to the high-pass ports of the diplex filters for passing the MoCA signals between the splitter means and the first diplex filters.

In another embodiment, a CATV point of entry adapter includes an input for receiving CATV signals, and first and second splitters with a first plurality of outputs. The adapter also includes a first plurality of diplex filters, each having a low-pass port passing the CATV signals and a high-pass port passing MoCA signals, wherein each of the first plurality of outputs of the first and second splitters is connected to a respective one of the low-pass ports of the first plurality of diplex filters for passing the CATV signals between the input and the diplex filters. The adapter further includes a first plurality of access network ports, each coupled to the diplex filters for passing both the CATV and MoCA signals between the diplex filters and respective access network ports. The adapter still further includes splitter means having a second plurality of home network ports, wherein the splitter means is connected to the high-pass ports of each of the diplex filters for passing the MoCA signals between the splitter means and the diplex filters.

In yet another embodiment, a CATV point of entry adapter includes an input for receiving CATV signals, and a directional coupler and a splitter having a first plurality of outputs, wherein the directional coupler is connected to the splitter. The adapter further includes a first plurality of diplex filters, each having a low-pass port passing the CATV signals and a high-pass port passing MoCA signals, wherein each of the first plurality of outputs of the directional coupler and the splitter is connected to a respective one of the low-pass ports of the first plurality of diplex filters for passing the CATV signals between the input and the diplex filters. The adapter still further includes a first plurality of access network ports, each coupled to a respective one of the diplex filters for passing both the CATV and MoCA signals between the diplex filters and respective access network ports. The adapter still further includes splitter means having a second plurality of home network ports, wherein the splitter means is connected to the high-pass ports of each of the diplex filters for passing the MoCA signals between the splitter means and the diplex filters.

The above provides the reader with a very brief summary of some embodiments discussed below. Simplifications and omissions are made, and the summary is not intended to limit or define in any way the scope of the invention or key aspects thereof. Rather, this brief summary merely introduces the reader to some aspects of the invention in preparation for the detailed description that follows.

### BRIEF DESCRIPTION OF THE DRAWINGS

Referring to the drawings:

FIGS. 1-5 are functional block diagrams of embodiments of CATV point of entry adapters.

### DETAILED DESCRIPTION

Reference now is made to the drawings, in which the same reference characters are used throughout the different figures to designate the same elements. Reference now is made to the drawings, in which the same reference characters are used throughout the different figures to designate the same elements. The below presents five non-limiting exemplary embodiments of CATV point of entry adapters.

### A First Embodiment

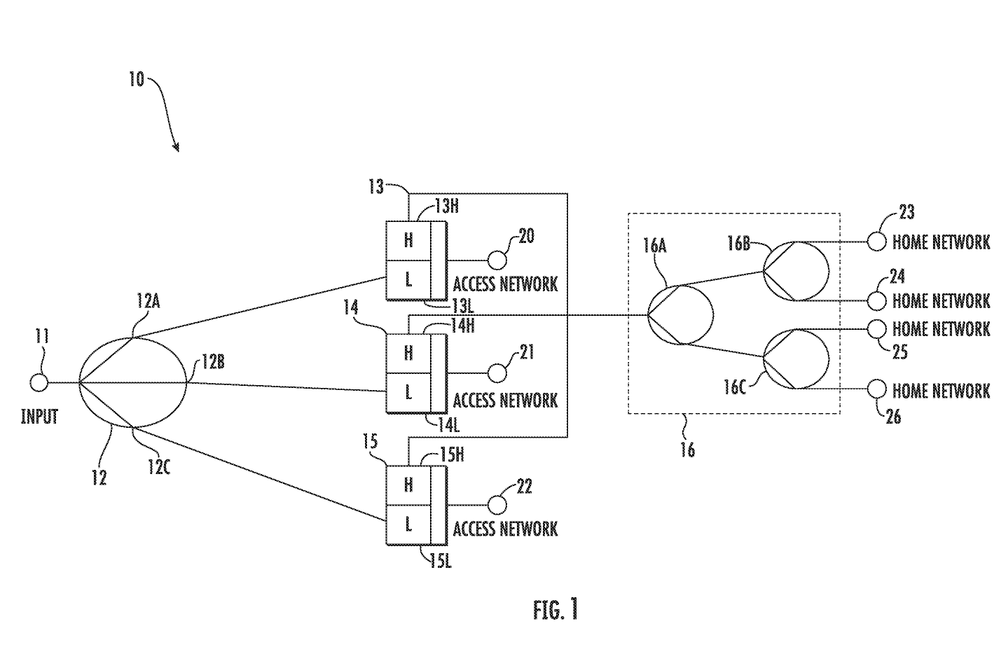

FIG. 1 illustrates a CATV point of entry adapter 10 (hereinafter, “adapter 10”) enabling higher-capacity services with isolated home network ports or MoCA-only ports designed for home network connectivity. Fewer access network ports enables the customer's electronic components to optimally connect to the access network ports or DOCSIS access network, while also minimizing upstream noise aggregation from the home network to the access network. The adapter 10 also enables MoCA signals to be communicated between access network ports and isolated home network ports, while preventing the MoCA signals from entering the CATV network infrastructure or a neighboring subscriber's network.

The adapter 10 shown in FIG. 1 receives communication services from an HFC plant (not shown, but upstream from an input 11 to the adapter 10), and it communicates those services onward to MoCA and CATV electronic components installed in a subscriber's home or premises. A bi-directional signal is transmitted to the input 11 of the adapter 10. One having ordinary skill in the art will appreciate that the input 11 is identified as an “input” for simplicity and that, when the HFC plant transmits a downstream signal to the adapter 10, the input 11 functions as an input, and when the adapter 10 transmits an upstream signal to the HFC plant or into the CATV network, the input 11 does not function as an input but rather as an output. Nevertheless, the term “input” is used herein for simplicity, as are terms like “downstream” and “upstream,” which are generally made with respect to a signal communicated to and from the adapter 10 from and to the HFC plant, respectively, unless otherwise indicated. One having ordinary skill in the art will appreciate that signals are transmitted bi-directionally through the adapter 10 (and the other adapters in this disclosure), but that the MoCA signals and CATV signals are selectivity transmitted, according to the structure and operation of the adapter 10, in different parts of the adapter 10. As such, the signals, the CATV signals, and the MoCA signals are not identified or referenced in the drawings, but are described in this written disclosure. The adapter 10 includes a three-way splitter 12, three diplex filters 13, 14, and 15 arranged in parallel, and a four-way splitter means 16, formed from three two-way splitters 16A, 16B, and 16C. The outputs of the splitter 16A are the inputs of the splitters 16B and 16C. FIG. 1, of course, is a functional block diagram, with various shapes representing functional components of the adapter. Lines between components represent leads, or electrically-conductive paths. These lines are not marked with reference characters.

The downstream signal to the adapter 10 is received at the input 11 and transmitted along a lead to an input of the splitter 12. The splitter 12 has three outputs 12A, 12B, and 12C, each of which is connected directly and only to the diplex filters 13, 14, and 15; none of the outputs 12A, 12B, and 12C are connected to anything else. The splitter 12 splits and transmits the signal to low-pass ports 13L, 14L, and 15L on each of the three diplex filters 13, 14, and 15. Each low-pass port is indicated in FIG. 1 with the respective diplex filter reference character appended with an “L”. The low-pass ports 13L, 14L, and 15L pass signal frequencies approximately in the 5 MHz to 1002 MHz range. Each of the diplex filters 13, 14, and 15 has a common port, or access network port 20, 21, and 22, respectively, which is coupled to an electronic component such as a cable modem, DVR, or other similar device. In this way, upstream and downstream signals approximately between 5 MHz and 1002 MHZ are transmitted between electronic components coupled to the access network ports 20, 21, and 22, and the input 11 (and ultimately, via the input 11, to the HFC plant).

Further downstream, the splitter means 16 includes four ports, identified in FIG. 1 as home network ports 23, 24, 25, and 26. Electronic components, such as DVRs, gaming devices, and over-the-top devices, within the home or premises are coupled to these home network ports 23-26. The splitter means 16 is coupled to each of the diplex filters 13, 14, and 15 through the high-pass ports 13H, 14H, and 15H of each. The high-pass ports 13H, 14H, and 15H pass signal frequencies approximately in the 1125 MHz to 1675 MHz range. As such, only MoCA signals—signals in the 1125 MHZ to 1675 MHz frequency band—are transmitted between the access network ports 20, 21, and 22 and the home network ports 23, 24, 25, and 26. This allows bidirectional MoCA communication between electronic components within the premises, but prevents the transmission of noise and MoCA signals upstream from the diplex filters 13, 14, and 15 to neighboring subscriber's premises or further up the access network beyond the input 11. In this way, privacy of intra-premises communications is maintained, and ingress noise to the CATV network is mitigated.

### A Second Embodiment

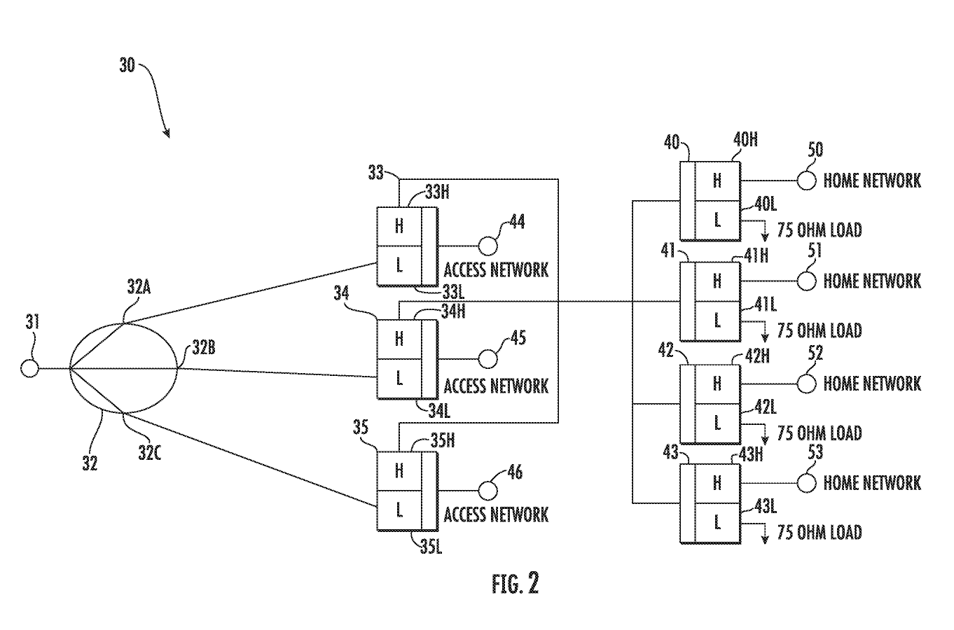

FIG. 2 shows an alternate embodiment of a CATV point of entry adapter 30 enabling higher-capacity services like the adapter 10. The adapter 30 enables MoCA signals to be communicated between access network ports and isolated home network ports, while preventing the MoCA signals from entering the CATV network infrastructure or a neighboring subscriber's network.

The adapter 30 shown in FIG. 2 receives communication services from an HFC plant (not shown, but upstream from an input 31 to the adapter 30), and it communicates those services onward to MoCA and CATV electronic components installed in a subscriber's home or premises. A bi-directional signal is transmitted to the input 31 of the adapter 30. The adapter 30 includes a three-way splitter 32, three upstream diplex filters 33, 34, and 35 arranged in parallel, and four downstream diplex filters 40, 41, 42, and 43 arranged in parallel as second splitter means. FIG. 2 is a functional block diagram, with various shapes representing functional components of the adapter 30. Lines between components represent leads, or electrically-conductive paths. These lines are not marked with reference characters.

The downstream signal to the adapter 30 is received at the input 31 and is transmitted to the splitter 32, which has three outputs 32A, 32B, and 32C, each of which is connected to one of the diplex filters 33, 34, and 35, respectively. The signal is split by at the splitter 32 and transmitted to low-pass ports 33L, 34L, and 35L on the diplex filters 33, 34, and 35, respectively. The low-pass ports 33L, 34L, and 35L pass signal frequencies in approximately the 5 MHz to 1002 MHz range. Each of the diplex filters 33, 34, and 35 has a common port, or access network port 44, 45, and 46, which is coupled to an electronic component such as a cable modem, DVR, or other similar device. In this way, upstream and downstream signals approximately between 5 MHz and 1002 MHz are transmitted between electronic components coupled to the access network ports 44, 45, and 46 and the input 31 (and ultimately, via the input 31, to the HFC plant).

The diplex filters 33, 34, and 35 each have high-pass ports 33H, 34H, and 35H. These high-pass ports 33H, 34H, and 35H are coupled to common ports of the four diplex filters 40, 41, 42, and 43, which collectively act as splitter means. The diplex filters 40, 41, 42, and 43 also have high-pass ports 40H, 41H, 42H, and 43H and low-pass ports 40L, 41L, 42L, and 43L. The low-pass ports 40L, 41L, 42L, and 43L are terminated with a 75-Ohm resistance load. The high-pass ports 40H, 41H, 42H, and 43H extend to home network ports 50, 51, 52, and 53, respectively, which are coupled to electronic components such as DVRS, gaming devices, and over-the-top devices within the home or premises. The high-pass ports 40H, 41H, 42H, and 43H may also be coupled to more conventional CATV, non-MoCA electronic components. With the electronic components coupled to the home network ports 50-53, and the diplex filters 40-43 coupled to the high-pass ports 33H, 34H, and 35H of the diplex filters 33, 34, and 35, respectively, MoCA signals—signals in the 1125 MHZ to 1675 MHz frequency band—are passed between the electronic components within the home or premises without transmitting beyond the diplex filters 33, 34, and 35. This allows bidirectional MoCA communication between electronic components within the premises, but prevents the transmission of noise and MoCA signals upstream past the diplex filters 33, 34, and 35 to neighboring subscriber's premises or further up the access network beyond the input 31. In this way, privacy of intra-premises communications is maintained, and ingress noise to the CATV network is mitigated.

### A Third Embodiment

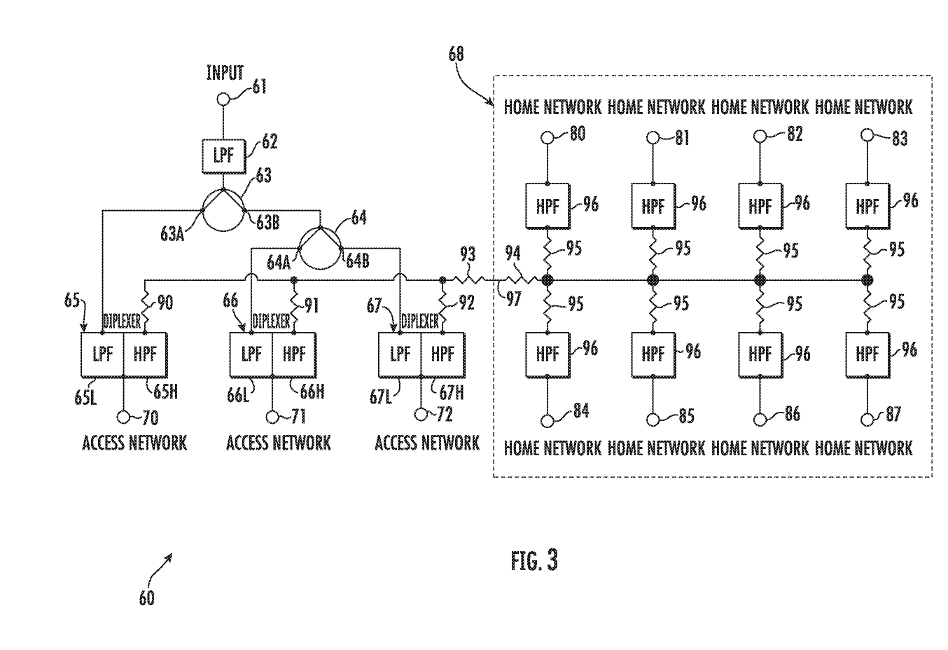

FIG. 3 illustrates another CATV point of entry adapter 60 (hereinafter, “adapter 60”) enabling higher-capacity services through isolated home network ports or MoCA-only ports designed for home network connectivity only. Fewer access network ports enables the customer's electronic components to optimally connect to the access network ports or DOCSIS access network, while also minimizing upstream noise aggregation from the home network to the access network. The adapter 60 also enables MoCA signals to be communicated between access network ports and isolated home network ports, while preventing the MoCA signals from entering the CATV network infrastructure or a neighboring subscriber's network.

The adapter 60 shown in FIG. 3 receives communication services from an HFC plant (not shown, but upstream from an input 11 to the adapter 60), and it communicates those services onward to MoCA and CATV electronic components installed in a subscriber's home or premises. A bi-directional signal is transmitted to the input 61 of the adapter 60. The adapter 60 includes a low-pass filter 62, two splitters 63 and 64, three diplex filters 65, 66, and 67 with three access network ports, and a resistive splitter 68 with a plurality of home network ports. FIG. 3 is a functional block diagram, with various shapes representing functional components of the adapter. Lines between components represent leads, or electrically-conductive paths. These lines are generally not marked with reference characters.

The downstream signal from the input 61 is transmitted through the low-pass filter 62, which passes signals of 1002 MHz and below to the splitter 63. The splitter 63 has two outputs 63A and 63B; the output 63A is connected directly to a low-pass port 65L of the diplexer 65, and the other output 63B is connected to the other splitter 64. That splitter 64 also has two outputs 64A and 64B, connected to the low-pass ports 66L and 66L of the diplexers 66 and 67, respectively. The low-pass ports 65L, 66L, and 67L pass signal frequencies approximately in the 5 MHz to 1002 MHz range. Though the output 63B is an output of the splitter 63, it is not an output of the splitters 63 and 64, together, as the output 63B merely connects the splitters 63 and 64 in series. Rather, the splitters 63 and 64 collectively have three outputs: output 63A, output 64A, and output 64B.

Each of the diplex filters 65, 66, and 67 has a common port, or access network port 70, 71, and 72, respectively, which is coupled to an electronic component such as a cable modem, DVR, or other similar device. In this way, upstream and downstream signals approximately between 5 MHz and 1002 MHZ are transmitted between electronic components coupled to the access network ports 65, 66, and 67, and the input 61 (and ultimately, via the input 11, to the HFC plant).

Downstream from the diplex filters 65, 66, and 67, the resistive splitter 68 has eight ports, identified as home network ports 80-87. Electronic components, such as DVRs, gaming devices, and over-the-top devices, within the home or premises are coupled to these home network ports 80-87. The resistive splitter 68 is coupled to the diplex filters 65, 66, and 67 through high-pass ports 65H, 66H, and 67H of each. The high-pass ports 65H, 66H, and 67H pass signal frequencies approximately in the 1125 MHz to 1675 MHz range between the resistive splitter 68 and the diplex filters 65, 66, and 67 for intra-premises MoCA communication. Only MoCA signals—signals in the 1125 MHZ to 1675 MHz frequency band—are transmitted between the access network ports 70, 71, and 72 and the home network ports 80-87. Further, the low-pass filter 62 filters signal frequencies above 1002 MHz and prevents them from entering or leaving the adapter 61. This allows bidirectional MoCA communication between electronic components within the premises, but prevents the transmission of noise and MoCA signals upstream from the diplex filters 65, 66, and 67 to neighboring subscriber's premises or further up the access network beyond the input 61. In this way, privacy of intra-premises communications is maintained, and ingress noise to the CATV network is mitigated.

The leads coupled to the high-pass ports 65H, 66H, and 67H include resistors 90, 91, and 92 before merging to a common lead 97 which includes another resistor 93. Within the resistive splitter 68, there is an upstream resistor 94 on the common lead 97, and then resistors 95 on each of the leads to the home network ports 80-87. The resistors 90, 91, and 92 are in parallel with each other and preferably have the same resistance as each other. The resistors 95 are in parallel with each other in the resistive splitter 68 preferably have the same resistance as each other. The resistors 95 are in series with the resistors 93 and 94 on the common lead 97. Between and in series with the resistors 95 and the home network ports 80-87, each lead includes a high-pass filter 96, which cuts out signal frequencies below 1125 MHz. This ensures that only MoCA signals are transmitted to and from the home network ports 80-87, and that CATV signals do not enter the adapter 60 at those ports.

### A Fourth Embodiment

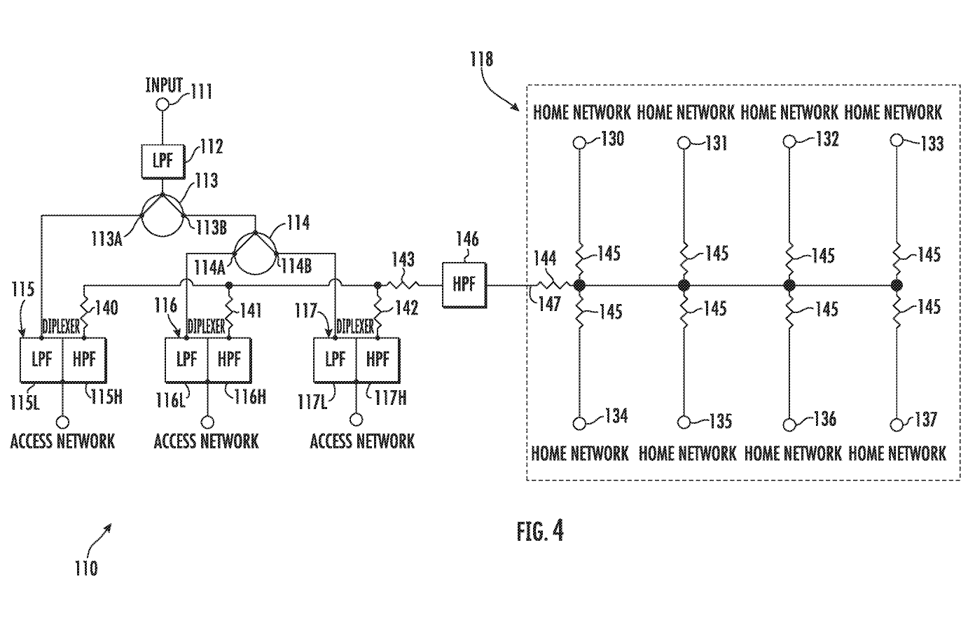

FIG. 4 illustrates yet another CATV point of entry adapter 110 (hereinafter, “adapter 110”). It is similar to the adapter 60 of FIG. 3 but lacks the high-pass filters 96 in the resistive splitter 68. The adapter 110 enables higher-capacity services with isolated home network ports or MoCA-only ports designed for home network connectivity only. Fewer access network ports enables the customer's electronic components to optimally connect to the access network ports or DOCSIS access network, while also minimizing upstream noise aggregation from the home network to the access network. The adapter 110 also enables MoCA signals to be communicated between access network ports and isolated home network ports, while preventing the MoCA signals from entering the CATV network infrastructure or a neighboring subscriber's network.

The adapter 110 shown in FIG. 4 receives communication services from an HFC plant (not shown, but upstream from an input 111 to the adapter 110), and it communicates those services onward to MoCA and CATV electronic components installed in a subscriber's home or premises. A bi-directional signal is transmitted to the input 111 of the adapter 110. The adapter 110 includes a low-pass filter 112, two splitters 113 and 114, three diplex filters 115, 116, and 117 with three access network ports, and a resistive splitter 118 with a plurality of home network ports. FIG. 4, of course, is a functional block diagram, with various shapes representing functional components of the adapter. Lines between components represent leads, or electrically-conductive paths. These lines are generally not marked with reference characters.

The downstream signal from the input 111 is transmitted through the low-pass filter 112, which passes signals of 1002 MHz and below to the splitter 113. The splitter 113 has two outputs 113A and 113B; the output 113A is connected directly to a low-pass port 115L of the diplexer 115, and the other output 113B is connected to the other splitter 114. That splitter 114 also has two outputs 114A and 114B connected to the low-pass ports 116L and 116L of the diplexers 116 and 117, respectively. The low-pass ports 115L, 116L, and 117L pass signal frequencies approximately in the 5 MHz to 1002 MHz range. Though the output 113B is an output of the splitter 113, it is not an output of the splitters 113 and 114, together, as the output 113B merely connects the splitters 113 and 114 in series. Rather, the splitters 113 and 114 collectively have three outputs: output 113A, output 114A, and output 114B.

Each of the diplex filters 115, 116, and 117 has a common port, or access network port 120, 121, and 122, respectively, which is coupled to an electronic component such as a cable modem, DVR, or other similar device. In this way, upstream and downstream signals approximately between 5 MHz and 1002 MHZ are transmitted between electronic components coupled to the access network ports 120, 121, and 122, and the input 11 (and ultimately, via the input 11, to the HFC plant).

Downstream from the diplex filters 115, 116, and 117, the resistive splitter 118 has eight ports, identified as home network ports 130-137. Electronic components, such as DVRs, gaming devices, and over-the-top devices, within the home or premises are coupled to these home network ports 130-137. The resistive splitter 118 is coupled to the diplex filters 115, 116, and 117 through high-pass ports 115H, 116H, and 117H of each. The high-pass ports 115H, 116H, and 117H pass signal frequencies approximately in the 1125 MHz to 1675 MHz range between the resistive splitter 118 and the diplex filters 115, 116, and 117 for intra-premises MoCA communication. Only MoCA signals—signals in the 1125 MHZ to 11175 MHz frequency band—are transmitted between the access network ports 120, 121, and 122 and the home network ports 130-137. Further, the low-pass filter 112 filters signal frequencies above 1002 MHz and prevents them from entering or leaving the adapter 111. This allows bidirectional MoCA communication between electronic components within the premises, but prevents the transmission of noise and MoCA signals upstream from the diplex filters 115, 116, and 117 to neighboring subscriber's premises or further up the access network beyond the input 111. In this way, privacy of intra-premises communications is maintained, and ingress noise to the CATV network is mitigated.

The leads coupled to the high-pass ports 115H, 116H, and 117H include resistors 140, 141, and 142 before merging to a common lead 147 which includes another resistor 143. Within the resistive splitter 118, there is an upstream resistor 144 on the common lead 147, and then resistors 145 on each of the leads to the home network ports 130-137. The resistors 140, 141, and 142 are in parallel with each other and preferably have the same resistance as each other. The resistors 145 in the resistive splitter 118 are arranged in parallel with each other and preferably have the same resistance as each other. The resistors 145 are in series with the resistor 144. Outside the resistive splitter 118, between and in series with the resistor 143 and the resistive splitter 118, is a high-pass filter which cuts out signal frequencies below 1125 MHz. This ensures that only MoCA signals are transmitted between the resistive splitter 118 and the access network ports 120, 121, and 122, and that CATV signals are not allowed into the adapter 110 beyond the resistive splitter 118.

### A Fifth Embodiment

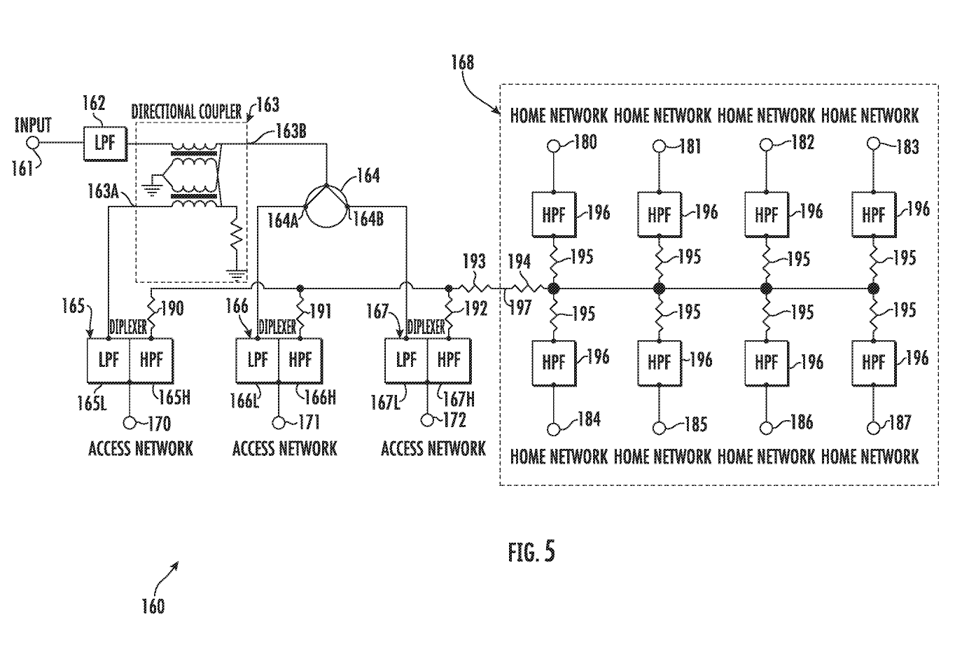

FIG. 5 illustrates still another CATV point of entry adapter 160 (hereinafter, “adapter 160”) enabling higher-capacity services with isolated home network ports or MoCA-only ports designed for home network connectivity only. Fewer access network ports enables the customer's electronic components to optimally connect to the access network ports or DOCSIS access network, while also minimizing upstream noise aggregation from the home network to the access network. The adapter 160 also enables MoCA signals to be communicated between access network ports and isolated home network ports, while preventing the MoCA signals from entering the CATV network infrastructure or a neighboring subscriber's network.

The adapter 160 shown in FIG. 5 receives communication services from an HFC plant (not shown, but upstream from an input 161 to the adapter 160), and it communicates those services onward to MoCA and CATV electronic components installed in a subscriber's home or premises. A bi-directional signal is transmitted to the input 161 of the adapter 160. The adapter 160 includes a low-pass filter 162, a directional coupler 163 and a splitter 164, three diplex filters 165, 166, and 167 with three access network ports, and a resistive splitter 168 with a plurality of home network ports. FIG. 5 is a functional block diagram, with various shapes representing functional components of the adapter. Lines between components represent leads, or electrically-conductive paths. These lines are generally not marked with reference characters.

The downstream signal from the input 161 is transmitted through the low-pass filter 162, which passes signals of 1002 MHz and below to the directional coupler 163. The directional coupler 163 has two outputs 163A and 163B; the output 163A is connected directly to a low-pass port 165L of the diplexer 165, and the other output 163B is connected to the splitter 164. That splitter 164 also has two outputs 164A and 164B, connected to the low-pass ports 166L and 166L of the diplexers 166 and 167, respectively. The low-pass ports 165L, 166L, and 167L pass signal frequencies approximately in the 5 MHz to 1002 MHz range. Though the output 163B is an output of the directional coupler 163, it is not an output of the directional coupler 163 and splitter 164, together, as the output 163B merely connected the directional coupler 163 to the splitter 164. Rather, the directional coupler 163 and the splitter 164 collectively have three outputs: output 163A, output 164A, and output 164B.

Each of the diplex filters 165, 166, and 167 has a common port, or access network port 170, 171, and 172, respectively, which is coupled to an electronic component such as a cable modem, DVR, or other similar device. In this way, upstream and downstream signals approximately between 5 MHz and 1002 MHZ are transmitted between electronic components coupled to the access network ports 170, 171, and 172, and the input 161 (and ultimately, via the input 161, to the HFC plant).

Downstream from the diplex filters 165, 166, and 167, the resistive splitter 168 has eight ports, identified as home network ports 180-187. Electronic components, such as DVRs, gaming devices, and over-the-top devices, within the home or premises are coupled to these home network ports 180-187. The resistive splitter 168 is coupled to the diplex filters 165, 166, and 167 through high-pass ports 165H, 166H, and 167H of each. The high-pass ports 165H, 166H, and 167H pass signal frequencies approximately in the 1125 MHz to 1675 MHz range between the resistive splitter 168 and the diplex filters 165, 166, and 167 for intra-premises MoCA communication. Only MoCA signals—signals in the 1125 MHZ to 1675 MHz frequency band—are transmitted between the access network ports 170, 171, and 172 and the home network ports 180-187. Further, the low-pass filter 162 filters signal frequencies above 1002 MHz and prevents them from entering or leaving the adapter 161. This allows bidirectional MoCA communication between electronic components within the premises, but prevents the transmission of noise and MoCA signals upstream from the diplex filters 165, 166, and 167 to neighboring subscriber's premises or further up the access network beyond the input 161. In this way, privacy of intra-premises communications is maintained, and ingress noise to the CATV network is mitigated.

The leads coupled to the high-pass ports 165H, 166H, and 167H include resistors 190, 191, and 192 before merging to a common lead 197 which includes another resistor 193. Within the resistive splitter 168, there is an upstream resistor 194 on the common lead 197 and then resistors 195 on each of the leads to the home network ports 180-187. The resistors 190, 191, and 192 are in parallel with each other and preferably have the same resistance as each other. The resistors 195 in the resistive splitter 168 are in parallel with each other and preferably have the same resistance as each other. Between and in series with each of the resistors 195 and the home network ports 180-187, each lead includes a high-pass filter 196, which cuts out signal frequencies below 1125 MHz. This ensures that only MoCA signals are transmitted to and from the home network ports 180-187, and that CATV signals do not enter the adapter 160 at those ports.

A preferred embodiment is fully and clearly described above so as to enable one having skill in the art to understand, make, and use the same. Those skilled in the art will recognize that modifications may be made to the description above without departing from the spirit of the invention, and that some embodiments include only those elements and features described, or a subset thereof. To the extent that modifications do not depart from the spirit of the invention, they are intended to be included within the scope thereof.

The invention claimed is:

1. A CATV point of entry adapter comprising:
an input for receiving CATV signals;
a first splitter having a first plurality of outputs;
a first plurality of first diplex filters, each having a low-pass port passing the CATV signals and a high-pass port passing MoCA signals, wherein each of the first plurality of outputs of the first splitter is connected to a respective one of the low-pass ports of the first plurality of first diplex filters for passing the CATV signals between the input and the first diplex filters;
a first plurality of access network ports, each coupled a respective one of the first diplex filters for passing both the CATV and MoCA signals between the first diplex filters and access network ports; and
splitter means having a second plurality of home network ports, wherein the splitter means is connected to the high-pass ports of each of the first diplex filters for passing the MoCA signals between the splitter means and the first diplex filters.

2. The adapter of claim 1, wherein:
the splitter means includes a second splitter connected to third and fourth splitters; and
the second plurality of home network ports includes four home network ports.

3. The adapter of claim 2, wherein the second, third, and fourth splitters are two-way splitters.

4. The adapter of claim 1, wherein:
the first splitter having a first plurality of outputs has three outputs; and
the first plurality of first diplex filters includes three first diplex filters.

5. The adapter of claim 1, wherein the splitter means includes a plurality of second diplex filters, each having a low-pass port and a high-pass port.

6. The adapter of claim 5, wherein each of the high-pass ports of the second diplex filters is connected to a respective one of the second plurality of the home network outputs for passing the MoCA signals between the home network ports and the second diplex filters.

7. A CATV point of entry adapter comprising:
an input for receiving CATV signals;
first and second splitters with a first plurality of outputs;
a first plurality of diplex filters, each having a low-pass port passing the CATV signals and a high-pass port passing MoCA signals, wherein each of the first plurality of outputs of the first and second splitters is connected to a respective one of the low-pass ports of the first plurality of diplex filters for passing the CATV signals between the input and the diplex filters;
a first plurality of access network ports, each coupled to a respective one of the diplex filters for passing both the CATV and MoCA signals between the diplex filters and respective access network ports; and
splitter means having a second plurality of home network ports, wherein the splitter means is connected to the high-pass ports of each of the diplex filters for passing the MoCA signals between the splitter means and the diplex filters.

8. The adapter of claim 7, wherein:
the splitter means includes a second plurality of high-pass filters in parallel, each connected to a respective one of the home network ports for passing the MoCA signals;
a second plurality of first resistors, each arranged in series with a respective one of the high-pass filters; and
second and third resistors, arranged in series with each of the second plurality of first resistors and the second plurality of high-pass filters.

9. The adapter of claim 7, wherein:
the splitter means includes a second plurality of first resistors, each connected to a respective one of the home network ports for passing the MoCA signals;
a second resistor, arranged in series with each of the second plurality of first resistors; and
a high-pass filter, arranged in series with the second resistor.

10. The adapter of claim 7, further including a low-pass filter between the input and the first splitter.

11. The adapter of claim 7, wherein the splitter means is connected to the diplex filters through resistors at each of the diplex filters.

12. The adapter of claim 7, wherein the first and second splitters are two-way splitters.

13. The adapter of claim 7, wherein:
the first splitter has two outputs;
the second splitters has two outputs; and
the first plurality of outputs is three outputs.

14. A CATV point of entry adapter comprising:
an input for receiving CATV signals;
a directional coupler and a splitter having a first plurality of outputs, wherein the directional coupler is connected to the splitter;
a first plurality of diplex filters, each having a low-pass port passing the CATV signals and a high-pass port passing MoCA signals, wherein each of the first plurality of outputs of the directional coupler and the splitter is connected to a respective one of the low-pass ports of the first plurality of diplex filters for passing the CATV signals between the input and the diplex filters;
a first plurality of access network ports, each coupled to a respective one of the diplex filters for passing both the CATV and MoCA signals between the diplex filters and respective access network ports; and
splitter means having a second plurality of home network ports, wherein the splitter means is connected to the high-pass ports of each of the diplex filters for passing the MoCA signals between the splitter means and the diplex filters.

15. The adapter of claim 14, wherein:
the splitter means includes a second plurality of high-pass filters in parallel, each connected to a respective one of the home network ports for passing the MoCA signals;
a second plurality of first resistors, each arranged in series with a respective one of the high-pass filters; and
second and third resistors, arranged in series with each of the second plurality of first resistors and the second plurality of high-pass filters.

16. The adapter of claim 14, further including a low-pass filter between the input and the first splitter.

17. The adapter of claim 14, wherein the splitter means is connected to the diplex filters through resistors at each of the diplex filters.

18. The adapter of claim 14, wherein the splitter is a two-way splitter.

19. The adapter of claim 14, wherein:
the directional coupler has two outputs;
the splitter has two outputs; and
the first plurality of outputs is three outputs.
